(19) United States
(12) Patent Application Publication
(10) Pub. No.: US 2005/0065804 A1
(43) Pub. Date: Mar. 24, 2005

(54) Method and system for furnishing of customized information to venues targeted to selected audiences

(75) Inventors: Brian T. Worsham, Maple Valley, WA (US); Matthew I. Ullman, Seattle, WA (US)

Correspondence Address: STOEL RIVES LLP, 900 SW FIFTH AVENUE, SUITE 2600, PORTLAND, OR, 97204, US

(73) Assignee: The Cobalt Group, Inc., Seattle, WA (US)

(21) Appl. No.: 10/665,899

(22) Filed: Sep. 18, 2003

(51) Int. Cl. G06F 17/60

(52) U.S. Cl. 705/1; 705/8

(57) ABSTRACT

The invention is of a unique method and system for efficiently configuring, accessing, and furnishing of customized information about one or more objects from a database to one or more venues, each directed at particular audiences, where the audiences each have a different assigned status, based on the nature and quantity of information that is appropriate to make available to them. In order to customize the information, the total information about the object is conveniently divided into data subsets, and each venue is only permitted access to certain subsets of the information, based on rules pertaining to and associated with the particular venue. Moreover information about certain objects can be selectively screened off from certain specified venues.

### COPYRIGHT NOTICE

© 2003 The Cobalt Group, Inc. of Seattle, Wash. A portion of the disclosure of this patent document contains material which is subject to copyright protection. The copyright owner has no objection to the facsimile reproduction by anyone of the patent document or the patent disclosure, as it appears in the Patent and Trademark Office patent file or records, but otherwise reserves all copyright rights whatsoever. 37 CFR § 1.71(d).

### TECHNICAL FIELD

This invention relates to the field of information management, and more particularly relates to a method and system of providing only certain customized information about objects to identified groups of persons, based on the predetermined status of each group.

### BACKGROUND OF THE INVENTION

The dissemination of information has become increasingly sophisticated over the years and information is now furnished to a variety of audiences, each with different needs, in a variety of formats and media. For example, in a business that sells goods to several different kinds of buyers, there must be customized information about the goods for each buyer, whether retail or wholesale, or local or overseas. In many businesses, goods are held in inventory, and so input of data about inventory and maintaining/updating of that data has become increasingly complex over the years, for several reasons.

In general, inventory represents a large investment, and it is often desirable to restrict the size of this investment, consistent with maintaining service levels, in order to reduce the amount of working capital tied up in inventory. It is also desirable to turn over the inventory as quickly as possible to maintain cash flow. Further, and of more significance here, certain information about inventory items must be made accessible to potential audiences, such as customers and others with needs for information about inventories (“information users”), so that they can view the inventory items, and make purchase and/or other decisions. Frequently, these audiences do not each have the same “status”, so that the information about the inventory items that are presented must vary from one type of audience to another.

In general, the greater the number of identified audiences that are served, the more complex the data management for each item of inventory, about which selected customized information must be furnished to multiple audiences, becomes. Take, for example, “price” customization: if a vendor only sells a product to the retail market, the vendor needs to create a price category (attribute) of “retail price” and assign a monetary value to that category of price, but has no need to create a category of wholesale price for the product and therefore has no need to assign an actual quantity to such a price type. However, if a vendor sells a product to both the retail and wholesale markets, it is likely that the pricing of a particular item for the wholesale market might be different from its pricing for the retail market customer, and consequently at least two “price type” categories would be needed and different “prices” would need to be assigned to each type. As a further complexity, the vendor might sell products into the same market (e.g., retail) across several geographic locations (e.g., Canada, Mexico, and the United States), and values (quantities and/or localized language and currency) for the relevant price type may differ from one location to another, depending upon the market. Accordingly, even though the same product is being offered, information categories (attributes) or category values (such as specific quantities, features or manner—such as language—in which the value is expressed) of the product may be provided differently from one audience to another, depending upon the status of the audience. In some cases, an information category (attribute) may be irrelevant to an audience, such as a “reserve price” in a non-auction sales method or a wholesale price for a good only to be available to retail markets, and this also presents issues in information management.

With the increasing use of the internet for commercial purposes, vendors are able to present information about objects (goods or services, whether inventoried or not) on offer (sale, rental, trade, etc.) to a wide variety of customers and other users of information about the objects, each potentially having a different status. This presents issues with regard to the efficient entry of information about the object on offer, the selective updating of information, and the directing of preselected information about the objects to each of the audiences, based on status. Further, if any changes have to be made to the underlying information about the object, this information must generally be modified for each of the identified audiences. Accordingly, the input and maintenance of information regarding objects can rapidly become very complicated, time consuming, expensive and error prone depending upon the number of audience status groups, and the systems and skills of the data entry and maintenance personnel.

### SUMMARY OF THE INVENTION

The invention includes a unique method of efficiently configuring, accessing, updating, maintaining, and displaying or otherwise making available (“furnishing”) information about one or more objects from a database at a relevant venue (such as a website, radio station, or any other means for furnishing information) to one or more audiences, whether human (e.g. the object owner's agents or employees, individuals entrusted with the role of marketing the object, or shoppers) or automated (e.g., another computer application), where the audiences each have a different assigned status, based on the nature and quantity of information that is appropriate to make available to them. The total information about the object, in accordance with the invention, is conveniently divided into data subsets, and each audience is only permitted access to certain subsets of the information, based on rules pertaining to and associated with the particular venue for the audience.

The invention facilitates the updating and maintenance of the information at reduced cost by organizing the information, and using rules, associated with specific venues, to select subsets of information to furnish to appropriate audiences.

In one aspect, the invention is of a method of furnishing information about objects to a plurality of venues, such as websites, each visited by their respective audiences, where at least some of the websites display different information about the objects than others. The information that is displayed varies by venue, such as website, although there may be some considerable overlap in the information furnished at the various venues.

The method includes storing the information about the objects in an accessible database. The information about each object is configured into predetermined convenient subsets, and these subsets may be accessed independently from each other for furnishing to a venue. Rules, associated with each venue, are used to select subsets of the information about the objects and to provide only the selected subsets to each website. Rules are used (a) to select appropriate subsets of the information for one or more objects that are permitted to be furnished to the particular venue (the compilation of the subsets into furnished information presents an “object view to that venue); and (b) to aggregate these object views into groups that meet the same object view inclusion/exclusion criteria (“venue views”); and (c) to furnish the selected venue views to one or more venues, based on each particular venue's rule. These rules for creating object views, venue views, and making venue views available to one or more venues may be implemented manually or in a programmed (automated) manner, and may be based on implicit or explicit criteria. Thus, data compilation into subsets and applying rules permits customization of information for each venue and its associated audience(s).

In another aspect, the invention provides a system for providing information about objects to a plurality of venues, each having an associated audience(s), wherein certain audiences (and hence venues) are only permitted access to certain subsets of information about the objects, and other audiences are allowed access to other subsets of information, although there may be some commonality in the subsets accessed by each audience. The system includes at least one database wherein information about each object is configured into subsets, and the subsets of information may be accessed independently from each other. Each venue has associated rules, as discussed above and herein, for furnishing specific subsets of information about appropriate objects to the various venues and their respective associated audiences.

Whereas this system is particularly useful for displaying information to various audiences through the Internet, the system is not restricted to Internet use, and may also be used in a variety of other technologies that may be employed to present information selectively to particular audiences, for example venues may include any of broadcast radio, television, print media, telecommunications such as telephone and two-way radio, print and electronic signage, email, and traditional physical print and physical goods transfer modalities such as postal mail and direct handouts and flyers.

Additional aspects and advantages of this invention will be apparent from the following detailed description of preferred embodiments, which proceeds with reference to the accompanying drawings.

### BRIEF DESCRIPTION OF THE DRAWINGS

FIG. 1 is a schematic representation of information configured according to an embodiment of the invention for ease of access by rules;

FIG. 2 is a schematic representation of a plurality of venues, each having an associated rule, for accessing information from a database, in accordance with the invention;

FIG. 3 is a simplified graphic depiction of an embodiment of the invention illustrating venues accessing information using rules from multiple databases; and

FIG. 4 is a simplified graphic depiction of an embodiment of the invention illustrating the use of rules as criteria to limit the object views furnished to a venue.

### DETAILED DESCRIPTION OF PREFERRED EMBODIMENTS

The invention provides a methodology and system that is widely applicable for the furnishing of customized information about objects to various venues to be accessed by audiences.

In the specification and claims, the term “venue” means the smallest defined destination to which customized information is to be made available to one or more “audiences”, such as people and/or automated systems, wherein in each participant in the audience has been determined to have a common trait relating to the information or object, so that the audience has a “status” in the system and information is customized to meet the defined needs of the audience. For example, a marketing medium for retail customers in a particular geographic location may constitute an “venue” for a particular good or service. Thus, by way of illustration, if a website is created as a venue to market pre-owned vehicles in the Seattle area to retail customers, then these customers have retail purchasing as a common trait and are an “audience”. Further, the basis for establishing car pricing (or determining other information to be furnished) is uniform for this retail audience. The website accessible by this audience may constitute a venue to which many automobile dealers may wish to provide information about certain of their vehicles for retail sale. Similarly, a website for wholesale automotive customers nationwide may potentially constitute a venue, and the wholesale dealers may be an audience. However, if the wholesale customers may be further subdivided by other traits or factors, such as for example unique needs by geographic region, thus implying separate geographic niche markets and hence potentially separate audiences. Thus, one might create separate venues either as separate websites for each of the identified geographic wholesale customer subdivisions or audiences, or as separate venues within a common website where the audience from a particular region may be restricted to certain information by Rules set up in accordance with the invention, or by entering a zip code or other identifier to shift to an appropriate Rule governed venue within the site. Thus, distinct venues are created for each audience and each venue is defined by a set of unique “rules” for customizing the information which may be displayed at the particular venue, in this case a website(s). Clearly, venues can be defined by other criteria as well, depending on the objects being furnished and audience factors.

In the specification and claims, the term “object” relates to the actual goods or services being offered. The term “offer” or “furnish” in reference to an object means being offered or furnished for sale, rental, lease, or any other means by which control, use of, access to, or ownership of objects of the kind can be provided or transferred. The term “furnish” as it relates to information, means making the information available whether in an object view, venue view or other format and whether by audio or video or both means.

The term “attribute” refers to each category of information that might be used to describe an object. For example, the color of an object, or a price for a specific venue—which can be retail, wholesale, discounted, special, etc.

The term “object view” means the information furnished for an object to a particular venue, and that information is customized through the use of Rules, in accordance with the invention.

The term “venue view” means the totality of the view of information furnished to an audience at a particular venue, and this view will include at least one, and usually many, object views designed or customized for the particular venue.

The term “display” when used in connection with objects being offered, or information about the objects, should be read broadly to include visual display, audio display and combined audio-visual display.

It should be understood that while much of the description of the invention that follows deals with furnishing customized information regarding objects being offered through the Internet, the furnishing of information according to the invention is not limited only to website venues via the video display units of audiences, but includes use of other media such as broadcasting to audiences through radio, tv, telephone, text messaging, email, multi media messaging, 2-way radio, proprietary computer networks, distribution via print media, etc.

In one aspect of the invention, information about objects is compiled into a database, which means any defined repository of information from which information can be recovered for furnishing to audiences. This database may be a single database, or a composite made up of several databases, as discussed below.

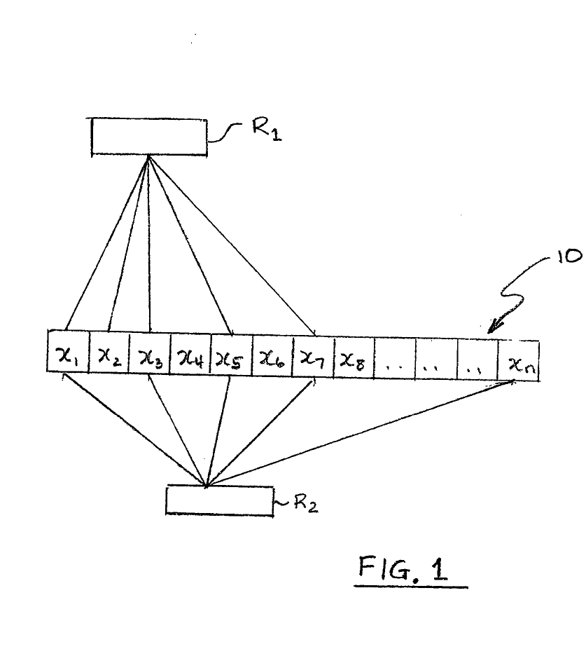

Aspects of the invention may be better appreciated with reference to examples and illustrations. Thus, referring to the example of FIG. 1, information about an object is represented as a data field 10 in a software database, wherein each field 10 has data subsets represented by x₁, x₂, x₃ . . . xₙ. Thus, the subsets x₁₋xₙ are intended to define all of the n attributes of the object that will be offered.

The example of FIG. 1 also illustrates two rules, designated R₁ and R₂. Clearly, as many rules as are necessary can be configured, each of the rules being associated with a particular venue that is in turn associated with an audience. Thus, for the venue that is associated with rule R₁, the rule will compile attribute information x₁, x₂, x₃, x₅, and x₇. This is then the only information that will be provided to the venue associated with R₁. On the other hand, the information supplied to the venue associated with rule R₂ includes attributes x₁, x₃, x₅, x₇ and xₙ.

As can be seen from the above example, a judicious selection of the attributes x₁ . . . xₙ will subdivide all of the information about any object so as to permit the customization of information about the object that is presented to an audience of a particular venue associated with the particular rule.

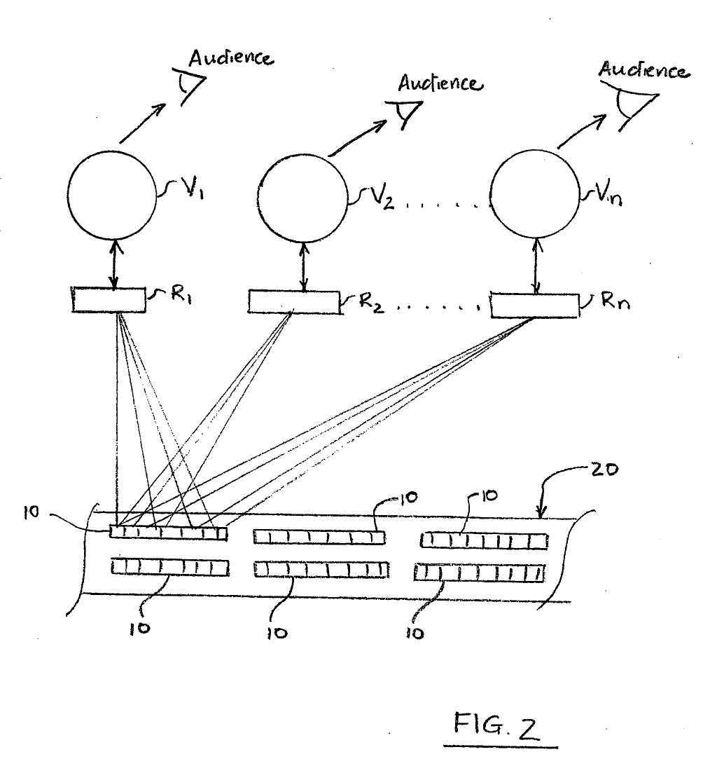

FIG. 2 is another example that graphically illustrates a series of venues that are provided with information accessed from a database comprising information about a variety of objects. In FIG. 2, the database 20 has information about a plurality of objects, arranged in data fields 10. As shown previously in FIG. 1, each data field 10 is subdivided into subsets. In FIG. 2, rules R₁, R₂, R₃ . . . Rₙ are each shown selectively accessing only the data fields of certain specific objects in database 20, and data fields of other objects cannot be accessed. Each of the data fields 10 relates to a particular object, and not all objects are accessed by each rule, in this example. Further, the rule selects from the particular subsets (of attributes) of the specified object x₁ . . . xₙ to compile the information about the object that will be presented to the venue associated with that rule in an object view. Thus, rule R₁ presents the information about the object that it selects from data file 10 to its associated venue V₁, rule R₂ presents information to its associated venue V₂, and so on.

In general, in the foregoing embodiment of the invention, each rule is configured to include only those objects that meet specified criteria (and to exclude others) and to select only those attributes of the included objects that meet other criteria set for a venue associated for that rule. Thus, for example, if a potential retail used car customer were to access a website dedicated to used Volkswagen cars, then this website venue would have an associated rule that (a) selects only used Volkswagen cars and excludes other brands of used cars that may also appear in databases accessible to the venue, and (b) furnishes only the information about used Volkswagen cars predetermined as appropriate to that venue. Clearly, this exclusion and selection processes can be carried out by one rule, or by a separate screening rule to exclude objects failing to meet a criterion (e.g. not used Volkswagen) and selection rules (e.g. that select used Volkswagen attributes to furnish to the retail venue) associated with the venue. Both systems are embodied in the invention.

As can be readily understood, the information provided to venues V₁, V₂, V₃, . . . Vₙ, will usually overlap to some extent. If the object is a shirt, for example, there may be certain attributes that are shown in each venue, and these might include color, size and sleeve length as the information needed by all potential venues for an audience buy decision. On the other hand, the rules also select from among the subsets of data that contain attributes that are only furnished to select venues associated with that particular rule. For example, shirt price will vary by retail or wholesale market and so the rules according to the invention will select an appropriate price for each venue from the price attributes. In accordance with the invention, these multiple venues can operate virtually simultaneously since the rules of the different venues selecting data do not interfere with each other.

The communication of selected information to each of the audiences may be carried out through any one of a number of means. For example, the system as described in FIG. 2 may employ well known web technology to communicate information to various websites accessible by the particular audiences, based on audience status, through audio-visual means, or through visual only means, including pictures and other associated graphics. Similarly, the information may be communicated to selected venues through a variety of mass communications means, as detailed herein. Preferably, the communication methodology should be selected as appropriate for the audience and the object about which information is being furnished, according to the invention.

In the context of the automobile industry, an object may be a car, and information about the car may include certain information such as make, model, vehicle identification number, mileage, and year of manufacture that is of interest to all venues, and so is furnished to all. Other information, that may be of interest to only particular venues, but not in others, or that may have local meaning, may include different information such different prices, equipment level descriptions, condition information, history, conditions of sale, duration of offer, localized languages and symbols, and the like. The new car may be offered for sale by an automobile dealership. Thus, the information about the car is entered into a data field 10 of database 20, as shown in FIG. 1. The database 20 is accessible to an audience of potential retail customers based on a selection of the information, as shown in FIG. 2. At the same time, some of the information may also be accessible to other new car dealers dealing in the same brand, at a different venue representing this different audience, to permit trading of new car stock between dealers within the same brand. The information available to the venue of these new car dealers, may however be different from that shown to retail customers, and would be selected using a different rule, as shown in FIG. 2,

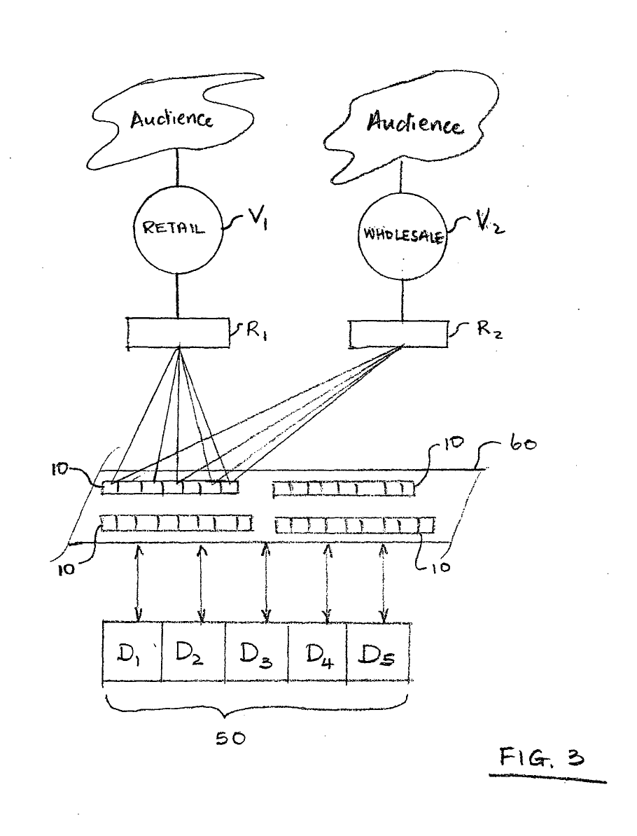

Continuing with automotive industry examples, FIG. 3 illustrates a partial simplified graphical representation of an embodiment of the invention for used car sales from a group of associated dealers. As can be seen in FIG. 3, the dealer group 50 includes five dealers, designated D₁, D₂, D₃, D₄, and D₅ that may be located in different areas in a common larger region. Each of these dealers may input information regarding used cars on their car lots into a database 60, that may be a common database into which each of them inputs information, or that may be a compilation of separate databases that each dealer maintains, and that are accessible to the rules used in the system. As long as these databases are accessible, and preferably use the same configuration of information regarding used cars, i.e. subdividing the information into subsets, as shown for example in FIG. 1, the method and system of the invention can be readily applied. Thus, for example, a retail customer as part of an audience at a venue V₁ may access information at the venue that uses rule R₁, regarding used cars from all of the dealers in the dealer group, by visiting the dealer group website or the website of a particular one of the five dealers, without even being aware that the car of interest might be on the lot of another dealer within the group. Similarly, another audience, a wholesale dealer audience at another venue V₂, for example, may also access the information through, for example, a differently configured website in order to select automobiles for wholesale purchase from the dealer group, or from any dealer within the group. The information displayed to the wholesale dealer (buyer) is controlled by the rules associated with the wholesale dealer website V₂, and these rules will permit the display of information more appropriate to wholesale dealers, than to the retail buyer, who accesses different information through the retail website venue V₁.

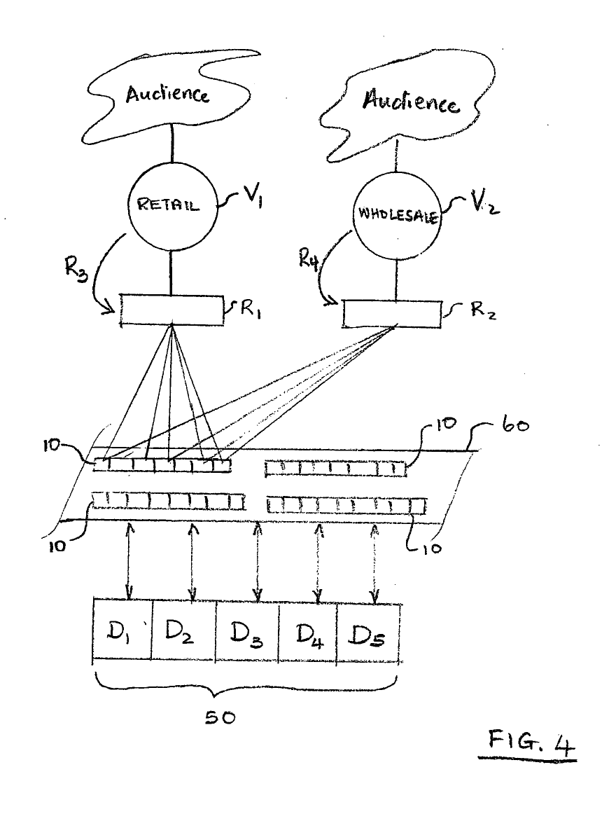

FIG. 4 illustrates is a partial and simplified graphical representation of an embodiment of he invention for used car sales from a group of associated dealers. This is automotive industry example of an alternative implementation in which the rules for the customized information to be made available to the venue are explicitly provided by the venue to the system and automatically interpreted by the system to create its own rules to provide information back to the venue. Such a system can, for example, control which objects are shown on a particular venue. A need for this arises whenever a potential customer, for example, goes to a venue for a particular brand of goods, but the databases contain multiple brands and so brands other than that associated with the venue must be “screened out” or “filtered out” and not furnished to the venue.

As can be seen in FIG. 4, the dealer group 50 includes five dealers, each with a database designated D₁, D₂, D₃, D₄, and D₅. The dealers may be located in different geographic areas in a common larger region. Each of these dealers may input information regarding used cars on their car lots into a database 60, that may be a common database into which each of them inputs information, or that may be a compilation of separate databases that each dealer maintains. Nonetheless, as long as these databases are accessible, and preferably use the same configuration of information regarding used cars, i.e. subdividing the information into subsets, as shown for example in FIG. 1, the method and system of the invention can be readily applied. Thus, a retail customer as part of the intended audience of the website venue V₁, may access information provided to the venue. In accordance with the invention, the rule R₁ is applied, and the venue also automatically applies a filtering rule R₃, to all used cars from all of the dealers in the dealer group that are developed by rule R₁. Thus, for example, a potential retain customer visiting the dealer group venue (website), or the website of a particular one of the five dealers may view car brands of choice, without even being aware that there are cars other than of the brands of interest on the lots of dealers within the group. The potential customer may not even be aware that cars of interest shown are located at a particular dealer within the group, unless the rule R₁ and the filter rule R₃ permit that information to be furnished. Similarly, another venue , a wholesale dealer website V₂, for example, may also access the information through, but the website would be differently configured in terms of rules and what information is furnished. The information here would be directed to facilitate wholesale purchase from the dealer group, or from any dealer within the group. The information provided to the website venue for the wholesale dealer (buyer) is controlled by the rules automatically generated by the system using the explicit venue rules R₂ for this wholesale dealer website venue V2, and filtering the information automatically prior to furnishing using rule R₄. These combined rules will provide information more appropriate for display to wholesale dealers than to the retail buyer, who accesses different information through the retail website venue.

Clearly, other techniques than those shown in FIG. 4 can be used to screen out certain objects from certain venues. For example, one of the data fields of each object could be coded as an identifier, and the rules associated with the venues, rules R₁ and R₂ in FIG. 4, could be configured to exclude or include objects based on the identifier of the object for furnishing to their respective venue. Such a system dispenses with the need for additional filtering rules shown in FIG. 4, designated R₃ and R₄. Clearly, a criterion limiting the objects to be furnished to a particular venue can be set up in a variety of different ways, depending upon convenience, efficiency and cost and the invention is not restricted to the use of any one method for achieving this end.

While the foregoing examples have dealt with the automotive context, it is clear that the invention is applicable to a wide range of goods and services that are commercially offered. The technology of the invention greatly simplifies the input and maintenance of information that must be supplied to a variety of potential audiences, and permits ready customization of the information for the particular audience.

It will be obvious to those having skill in the art that many changes may be made to the details of the above-described embodiments without departing from the underlying principles of the invention. The scope of the present invention should, therefore, be determined only by the following claims.

1. A method of furnishing information about objects to a plurality of venues, at least some of the information furnished to each venue differing from information furnished to other venues, the method comprising:
(i) storing information about objects in an accessible database, information about each object configured to permit independent access to subsets of the information about each object; and
(ii) using rules associated with each venue to select subsets of the information about each object; and
(ii) furnishing the rule-selected subsets of information to the respective venues associated with each rule.

2. The method of claim 1, wherein the rules associated with certain venues exclude information about certain objects from their respective associated venues.

3. The method of claim 2, wherein the excluding of information by a rule is based on the venue associated with the rule, or is based on the nature of the objects.

4. The method of claim 1, wherein the objects are vehicles and the information is contained in a plurality of databases.

5. The method of claim 4, wherein the venues are websites and the websites are selected from: a website accessible to retail customers, a website accessible to dealers and a website accessible by wholesale customers.

6. The method of claim 1, wherein the venues are websites.

7. The method of claim 6, further comprising using criteria to exclude information about certain objects from specified websites.

8. The method of claim 7, wherein the rules associated with the websites comprise the criteria for excluding information about certain objects.

9. A system for furnishing information about objects to a plurality of venues, wherein information furnished to each venue is customized based on an expected audience at the venue, the system comprising:
(a) a database comprising information about the objects, the information configured into subsets to permit access to at least some subsets of the information independently of other subsets;
(b) rules associated with each of the venues, each rule selecting specific subsets of the information for presentation to an associated venue; and
(c) means for providing the venues with access to their rule-selected subsets of information.

10. The system of claim 9, further comprising exclusion criteria, the criteria excluding information about specific objects from some venues.

11. The system of claim 9, wherein the means for providing access comprises the Internet, and the venues each comprise a website.

12. The system of claim 10, wherein the means for providing access comprises the Internet, and the venues each comprise a website.

13. The system of claim 11, wherein the objects comprise vehicles for sale or other means of trade.

14. The system of claim 10, wherein the rules comprise the exclusion criteria.

15. A method of providing information about objects to a plurality of venues, the information customized for each venue, the method comprising:
(a) storing information about the objects in an accessible database, information about each object configured to permit independent access to subsets of the information; and
(b) using rules, associated with each venue, to select subsets of the information to be provided to their respective venue.

16. The method of claim 12, further comprising using criteria, associated with each venue, to limit the objects about which the rule associated with the venue can provide information to that venue.

17. The method of claim 15, further comprising communicating the selected subsets of information about the objects to the respective venues by means of the Internet.

18. The method of claim 16, further comprising communicating the selected subsets of information about the objects to the respective venues by means of the Internet.
